(19) United States
(12) Patent Application Publication
(10) Pub. No.: US 2022/0043694 A1
(43) Pub. Date: Feb. 10, 2022

(54) SYSTEM AND METHOD FOR ALLOCATION OF RESOURCES WITHIN AN ENVIRONMENT

(71) Applicant: BANK OF AMERICA CORPORATION, CHARLOTTE, NC (US)

(72) Inventors: Suki Ramasamy, Chennai (IN); Anusha Balasubramanian, Chennai (IN); Thilaga Kannappan, Chennai (IN); Deve Madhavan Nair, Chennai (IN); Suganya Markandan, Chennai (IN); Kalpana Rajashekar, Chennai (IN); Vishnurupa Nemili Ramachandran, Chennai (IN)

(73) Assignee: BANK OF AMERICA CORPORATION, Charlotte, NC (US)

(21) Appl. No.: 16/986,568

(22) Filed: Aug. 6, 2020

(51) Int. Cl. G06F 9/50

(52) U.S. Cl. CPC G06F 9/5083

(57) ABSTRACT

Embodiments of the present invention provide a system for allocating resources to one or more users within an environment. The system is configured for registering one or more users of an entity to a closed distributed register, registering one or more resources of the entity to the closed distributed register, establishing a communication link with one or more entity systems, wherein the one or more entity systems are located in the environment of the entity, identifying one or more patterns associated with the one or more users based on the communication link with the one or more entity systems, and allocating the one or more resources to the one or more users based on the one or more patterns.

### BACKGROUND

Conventional systems do not have the capability to allocate resources in an efficient manner, thereby resulting in underutilization of resources. As such, there exists a need for a system that efficiently allocates resources within an environment.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for allocating resources to one or more users within an environment. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention registers one or more users of an entity to a closed distributed register, registers one or more resources of the entity to the closed distributed register, establishes a communication link with one or more entity systems, wherein the one or more entity systems are located in the environment of the entity, identifies one or more patterns associated with the one or more users based on the communication link with the one or more entity systems, and allocates the one or more resources to the one or more users based on the one or more patterns.

In some embodiments, the present invention identifies the one or more patterns based on tracking activity of the one or more users via the one or more entity systems for a period of time.

In some embodiments, the present invention in response to identifying the one or more patterns of the one or more users, stores the one or more patterns in a data repository.

In some embodiments, the present invention determines that at least one user is deviating from an established pattern associated with the at least one user based on the communication link with the one or more entity systems, identifies that at least one resource of the one or more resources is allocated to the at least one user, and reallocates the at least one resource to at least one other user.

In some embodiments, the present invention receives a request from a first user to reserve a first resource for a future time period, via the one or more entity systems and in response to receiving the request from the first user, allocates the first resource to the first user for the future time period.

In some embodiments, the one or more resources comprise at least one of tangible resources, intangible resources, digital resources, and dependent resources.

In some embodiments, the one or more entity systems comprise at least one of one or more entity applications, one or more mobile applications, and one or more independent platforms.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for allocating resources to one or more users within an environment, in accordance with an embodiment of the invention;

FIG. 2 provides a block diagram illustrating the entity system 200 of FIG. 1, in accordance with an embodiment of the invention;

FIG. 3 provides a block diagram illustrating an intelligent resource allocation system 300 of FIG. 1, in accordance with an embodiment of the invention;

FIG. 4 provides a block diagram illustrating the computing device system 400 of FIG. 1, in accordance with an embodiment of the invention;

FIG. 5 provides a flowchart illustrating a process flow for allocating resources to one or more users within an environment, in accordance with an embodiment of the invention; and

FIG. 6 provides a block diagram illustrating the process of allocating resources to one or more users within an environment, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “entity” or “resource entity” may include any organization that utilizes one or more resources and/or one or more entity systems (e.g., computing devices, applications, or the like) to perform organization activities. In some embodiments, the entity may be any organization that processes resource distributions (e.g., financial transactions) including, but not limited to, banks, credit unions, savings and loan associations, investment companies, stock brokerages, management firms, insurance companies and the like. In some embodiments, the entity may be a non-financial institution. Furthermore, embodiments of the present invention use the term “user” and the user may be an employee of the entity. In some embodiments, the user may be a contractor, sub-contractor, associate, or the like.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

“Distributed register,” which may also be referred to as a “distributed ledger,” as used herein may refer to a structured list of data records that is decentralized and distributed amongst a plurality of computing systems and/or devices. In some embodiments, the distributed ledger may use a linked block structure.

“Linked block,” “linked block structure,” “linked structure,” or “blockchain” as used herein may refer to a data structure which may comprise a series of sequentially linked “blocks,” where each block may comprise data and metadata. The “data” within each block may comprise one or more “data record” or “transactions,” while the “metadata” within each block may comprise information about the block, which may include a timestamp, a hash value of data records within the block, a pointer (e.g., a hash value) to the previous block in the linked block structure, and/or any additional data created by the system of the present invention. In this way, beginning from an originating block (e.g., a “genesis block”), each block in the linked block structure is linked to another block via the pointers within the block headers. If the data or metadata within a particular block in the linked block structure becomes corrupted or modified, the hash values found in the header of the affected block and/or the downstream blocks may become mismatched, thus allowing the system to detect that the data has been corrupted or modified. In some embodiments of the present invention, a user may submit data associated with the creation of a new block associated with the linked block structure. For example, a user may initiate a transaction, where the data associated with the transaction is stored in a new block linked with the transaction.

A “linked block ledger” may refer to a distributed ledger which uses linked block data structures. Generally, a linked block ledger is an “append only” ledger in which the data within each block within the linked block ledger may not be modified after the block is added to the linked block ledger; data may only be added in a new block to the end of the linked block ledger. In this way, the linked block ledger may provide a practically immutable ledger of data records over time.

“Permissioned distributed ledger” as used herein may refer to a linked block ledger for which an access control mechanism is implemented such that only known, authorized users may take certain actions with respect to the linked block ledger (e.g., add new data records, participate in the consensus mechanism, or the like). Accordingly, “unpermissioned distributed ledger” as used herein may refer to a linked block ledger without an access control mechanism.

“Private distributed ledger” as used herein may refer to a linked block ledger accessible only to users or devices that meet specific criteria (e.g., authorized users or devices of a certain entity or other organization). Accordingly, a “public distributed ledger” is a linked block ledger accessible by any member or device in the public realm. In some embodiments of the present invention, the distributed ledger being described herein may be a permissioned distributed ledger. In some embodiments of the present invention, the distributed ledger being described herein may be a private distributed ledger.

“Node” as used herein may refer to a computing system on which the distributed ledger is hosted. In some embodiments, each node maintains a full copy of the distributed ledger. In this way, even if one or more nodes become unavailable or offline, a full copy of the distributed ledger may still be accessed via the remaining nodes in the distributed ledger system. That said, in some embodiments, the nodes may host a hybrid distributed ledger such that certain nodes may store certain segments of the linked block ledger but not others.

“Consensus,” “consensus algorithm,” or “consensus mechanism” as used herein may refer to the process or processes by which nodes come to an agreement with respect to the contents of the distributed ledger. Changes to the ledger (e.g., addition of data records) may require consensus to be reached by the nodes in order to become a part of the authentic version of the ledger. In this way, the consensus mechanism may ensure that each node maintains a copy of the distributed ledger that is consistent with the copies of the distributed ledger hosted on the other nodes; if the copy of the distributed ledger hosted on one node becomes corrupted or compromised, the remaining nodes may use the consensus algorithm to determine the “true” version of the distributed ledger. The nodes may use various different mechanisms or algorithms to obtain consensus, such as proof-of-work (“PoW”), proof-of-stake (“PoS”), practical byzantine fault tolerance (“PBFT”), proof-of-authority (“PoA”), or the like.

“Smart contract” as used herein may refer to executable computer code or logic that may be executed according to an agreement between parties upon the occurrence of a condition precedent (e.g., a triggering event such as the receipt of a proposed data record). In some embodiments, the smart contract may be self-executing code that is stored in the distributed ledger, where the self-executing code may be executed when the condition precedent is detected by the system on which the smart contract is stored.

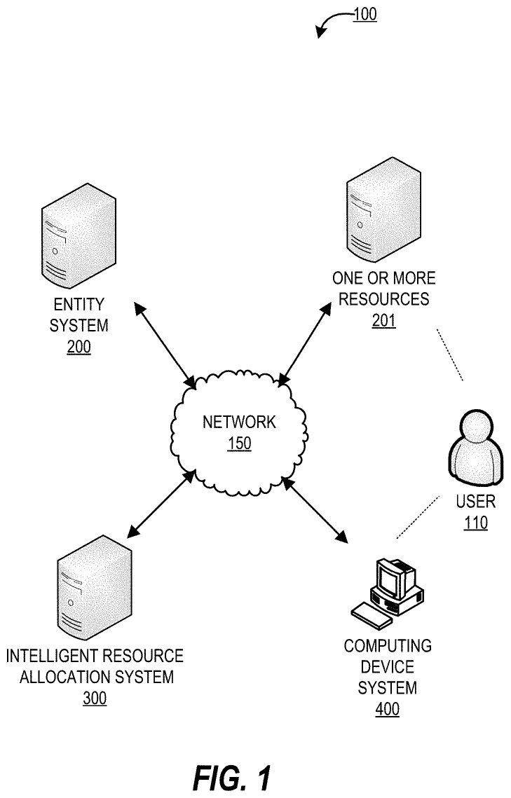

FIG. 1 provides a block diagram illustrating a system environment 100 for allocating resources to one or more users within an environment, in accordance with an embodiment of the invention. As illustrated in FIG. 1, the environment 100 includes a intelligent resource allocation system 300, entity system(s) 200, one or more resources 201, and a computing device system 400. The entity system(s) 200 may be any system owned or otherwise controlled by an entity to support or perform one or more process steps described herein. In some embodiments, the entity is a financial institution. In some embodiments, the one or more user(s) 110 of the system environment 100 may be employees of an entity associated with the entity system 200. One or more users 110 may be included in the system environment 100, where the users 110 interact with the other entities of the system environment 100 via a user interface of the computing device system 400. In some embodiments, the one or more resources 201 include the computing device system 400. In some embodiments, the one or more resources 201 may not include the computing device system 400 and in such instances, the computing device 400 may be a personal device of the user. One or more resources 210 associated with the entity may be any hardware resources, software resources, physical resources, or the like located in an environment of the entity.

The intelligent resource allocation system 300 is a system of the present invention for performing one or more process steps described herein. In some embodiments, the intelligent resource allocation system 300 may be an independent system. In some embodiments, the intelligent resource allocation system 300 may be a part of the entity system 200.

The intelligent resource allocation system 300, the entity system 200, the one or more resources 201, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the intelligent resource allocation system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the intelligent resource allocation system 300, and/or entity system 200 across the network 150. In some embodiments, the computing device system may be a resource provided by the entity.

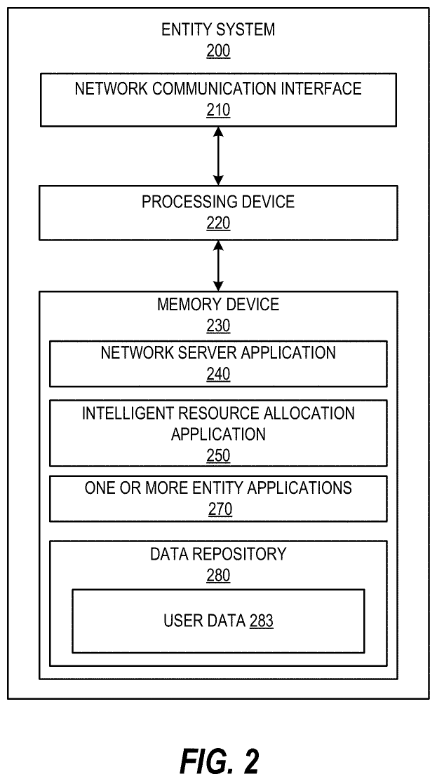

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution. In some embodiments, the entity system 200 may be operated by a non-financial entity.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, an intelligent resource allocation application 250, one or more entity applications 270, and a data repository 280 comprising information associated with user data 283. User data 283 may comprise authorization information, access information, resource usage information, pattern data generated by the intelligent resource allocation system 300, personal information, contact information, or the like. . The computer-executable program code of the network server application 240, the intelligent resource allocation application 250, the one or more entity application 270 to perform certain logic, data-extraction, and data-storing functions of the entity system 200 described herein, as well as communication functions of the entity system 200.

The network server application 240, the intelligent resource allocation application 250, and the one or more entity applications 270 are configured to store data in the data repository 280 or to use the data stored in the data repository 280 when communicating through the network communication interface 210 with the intelligent resource allocation system 300, and/or the computing device system 400 to perform one or more process steps described herein. In some embodiments, the entity system 200 may receive instructions from the intelligent resource allocation system 300 via the intelligent resource allocation application 250 to perform certain operations. The intelligent resource allocation application 250 may be provided by the intelligent resource allocation system 300. In some embodiments, one or more entity applications 270 may be any application utilized by the one or more users 110 to perform one or more organizational activities. In some embodiments, the one or mor entity applications 270 may be applications that allow the intelligent resource allocation system 300 to track activity of the one or more users 110.

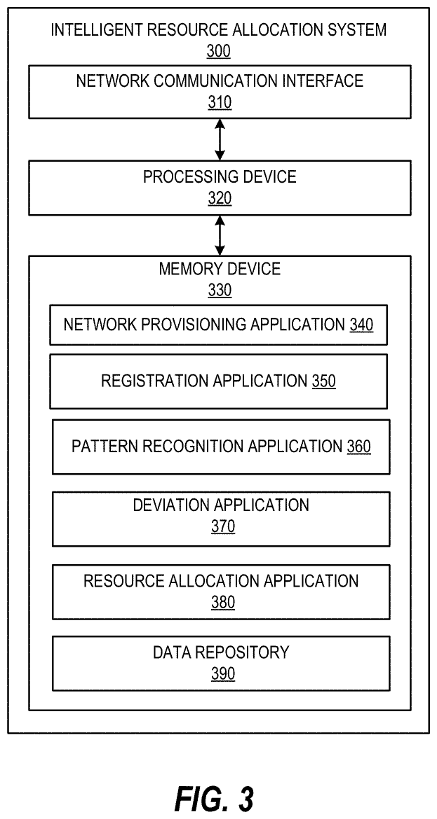

FIG. 3 provides a block diagram illustrating the intelligent resource allocation system 300 in greater detail, in accordance with embodiments of the invention. As illustrated in FIG. 3, in one embodiment of the invention, the intelligent resource allocation system 300 includes one or more processing devices 320 operatively coupled to a network communication interface 310 and a memory device 330. In certain embodiments, the intelligent resource allocation system 300 is operated by an entity, such as a financial institution. In certain embodiments, the intelligent resource allocation system 300 is operated by an entity, such as a non-financial institution. In some embodiments, the intelligent resource allocation system 300 is owned or operated by the entity of the entity system 200. In some embodiments, the intelligent resource allocation system 300 may be an independent system. In alternate embodiments, the intelligent resource allocation system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the intelligent resource allocation system 300 described herein. For example, in one embodiment of the intelligent resource allocation system 300, the memory device 330 includes, but is not limited to, a network provisioning application 340, a registration application 350, a pattern recognition application 360, a deviation application 370, a resource allocation application 380, and a data repository 390 comprising data processed or accessed by one or more applications in the memory device 330. The computer-executable program code of the network provisioning application 340, the registration application 350, the pattern recognition application 360, the deviation application 370, and the resource allocation application 380 may instruct the processing device 320 to perform certain logic, data-processing, and data-storing functions of the intelligent resource allocation system 300 described herein, as well as communication functions of the intelligent resource allocation system 300.

The network provisioning application 340, the registration application 350, the pattern recognition application 360, the deviation application 370, and the resource allocation application 380 are configured to invoke or use the data in the data repository 390 when communicating through the network communication interface 310 with the entity system 200, and/or the computing device system 400. In some embodiments, the network provisioning application 340, the registration application 350, the pattern recognition application 360, the deviation application 370, and the resource allocation application 380 may store the data extracted or received from the entity system 200, and the computing device system 400 in the data repository 390. In some embodiments, the network provisioning application 340, the registration application 350, the pattern recognition application 360, the deviation application 370, and the resource allocation application 380 may be a part of a single application.

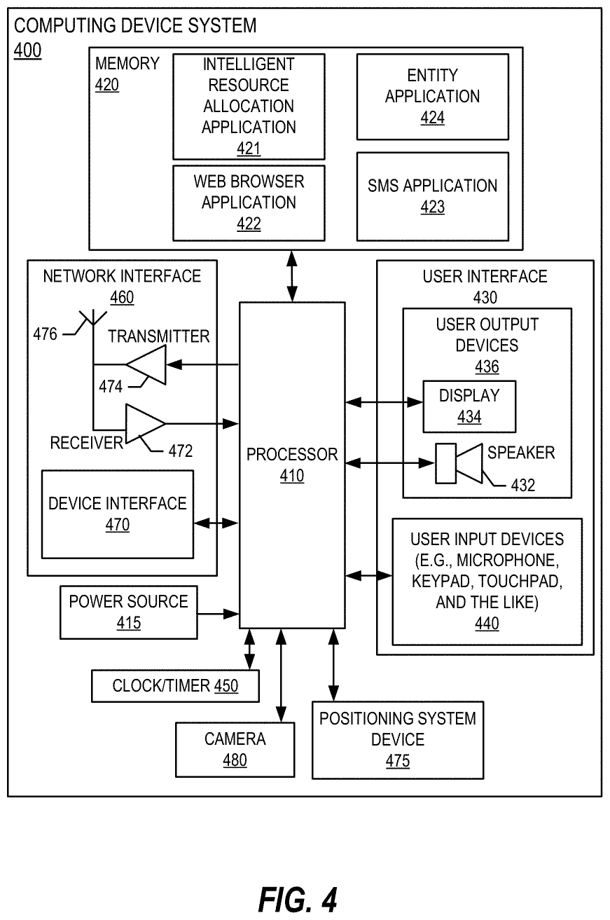

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an intelligent resource allocation application 421, entity application 424. These applications also typically instructions to a graphical user interface (GUI) on the display 430 that allows the user 110 to interact with the entity system 200, the intelligent resource allocation system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the intelligent resource allocation application 421 provided by the intelligent resource allocation system 300 allows the user 110 to access the intelligent resource allocation system 300. In some embodiments, the entity application 424 provided by the entity system 200 and the intelligent resource allocation application 421 allow the user 110 to access the functionalities provided by the intelligent resource allocation system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

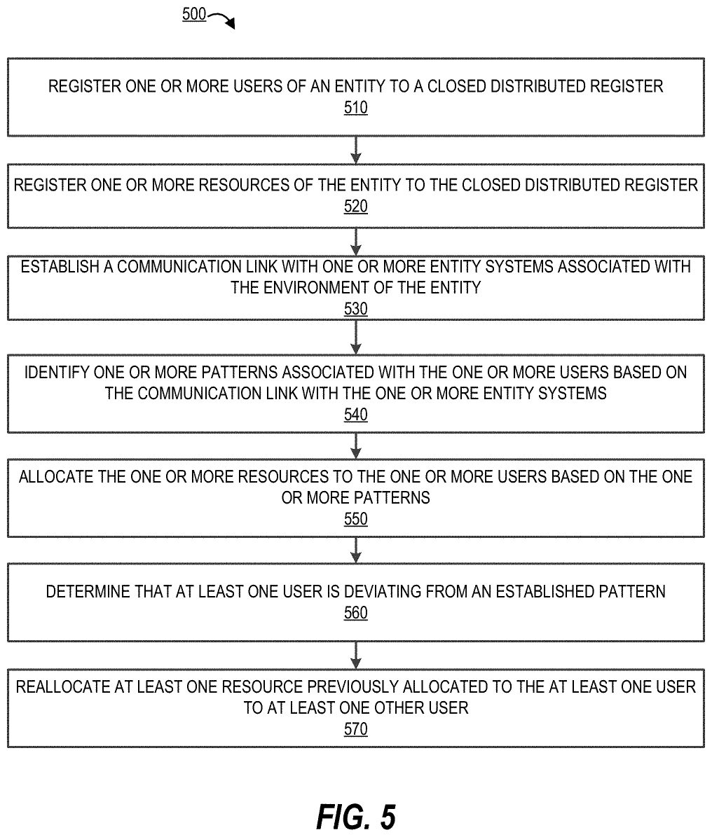

FIG. 5 provides a flowchart illustrating a process flow for allocating resources to one or more users within an environment, in accordance with an embodiment of the invention.

As shown in block 510, the system registers one or more users of an entity to a closed distributed register. The one or more users may be employees of the entity. Employees may include, but are not limited to, full time employees, part time employees, contractors, sub-contractors, associates, or the like. The closed distributed register may be a distributed register that is internal to the entity that allows the system to safely and efficiently allocate resources to the one or more users. In some embodiments, each of the one or more users may be blocks of the closed distributed register. In some embodiments, the at least a part of the system of the present invention may be a block of the closed distributed register that performs one or more steps described herein.

As shown in block 520, the system registers one or more resources of the entity to the closed distributed register. The one or more resources may comprise tangible resources (e.g., conference rooms, rooms with air conditioning, rooms with access to a projector, rooms with access to a white board, or the like), intangible resources (e.g., independent paid time off application, independent employee clock in system, or the like), digital resources (e.g., database, server, virtual server, digital application licenses, or the like), and dependent resources (e.g., email application, messenger application, or the like). In some embodiments, each of the one or more resources may be blocks of the closed distributed register.

As shown in block 530, the system establishes a communication link with one or more entity systems associated with the environment of the entity. The one or more entity systems may comprise any application, system, mobile application, or the like that allow system to track activities of the one or more users. For example, the entity system may be a system that gives one or more users access to a work space. In another example, the entity system may be a computing device system of a user, where the user logs into the computing device system to perform one or more organizational activities. In another example, the entity system may be a personal user device, where the user device may automatically connect to a beacon or an internal entity network that allows the system of the present invention to track the activity of the user.

As shown in block 540, the system identifies one or more patterns associated with the one or more users based on the communication link with the one or more entity systems. The system of the present invention tracks the activity of the one or more users over a time period, via the communication links established with the one or more entity systems, to establish the one or more patterns associated with the one or more users. For example, the system may communicate with the entity system that gives a first user access to the work location and may determine that the first user usually arrives to work between 9:00 AM and 9:30 AM. In another example, the system may communicate with the computing device system of the first user to determine that the first user usually schedules a meeting every alternate day of the week.

As shown in block 550, the system allocates the one or more resources to the one or more users based on the one or more patterns. The system automatically allocates the one or more resources based on the established patterns. Continuing with the previous example, the system determines that the first user usually schedules a meeting every alternate day of the week and reserves a conference room based on the preferences (e.g., conference room with a projector, or the like) established in the one or more patterns.

As shown in block 560, the system determines that at least one user is deviating from an established pattern. The system may constantly communicate with the one or more entity systems in real-time and may determine any deviations associated with the established one or more patterns. For example, the system may determine that the first user who usually arrives to the work location between 9:00 AM and 9:30 AM has not arrived between the time period established in the pattern and may determine a deviation in the pattern. The system may also store such changes or deviations in the data repository and may utilize this data for future allocation of resources.

As shown in block 570, the system reallocates at least one resource previously allocated to the at least one user to at least one other user. Continuing with the previous example, the system may determine that the first user is late to arrive to work and may check to see if any of the one or more resources are allocated to the first user. In response to determining that a first resource is allocated to the first user, the system may automatically reallocate the first resource to a second user. In some embodiments, the second user may be a user who is waiting in a queue for the first resource. In some embodiments, the system may dynamically determine the allocation of the first resource to at least one other user based on the activity of the one or more users and the one or more patterns of the one or more users. In some embodiments, the one or more users may submit requests to reserve the one or more resources. In some embodiments, such requests may be submitted via the closed distributed register.

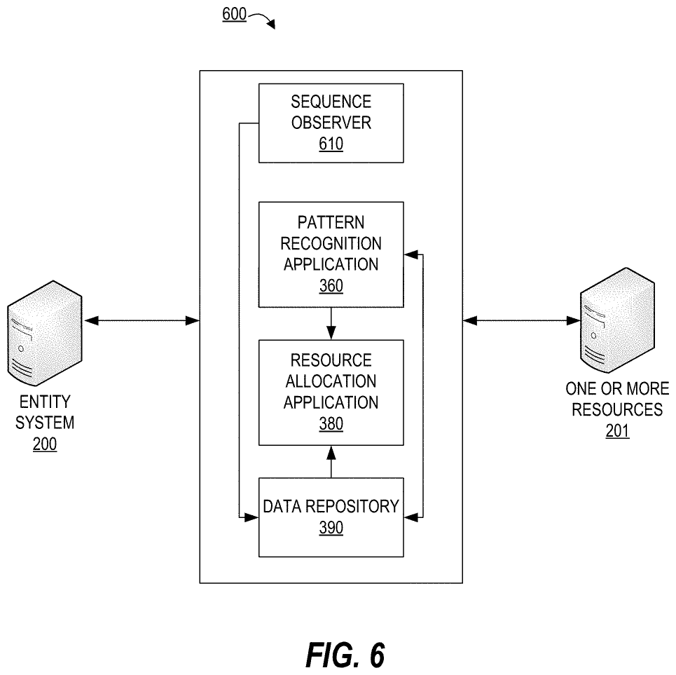

FIG. 6 provides a block diagram illustrating the process of allocating resources to one or more users within an environment, in accordance with an embodiment of the invention. As shown, the one or more entity systems 200 may provide data in real-time to the intelligent resource allocation system 300. The real-time data may be received by the sequence observer 610 and the resource allocation application 380, where the sequence observer 610 may determine sequence of user actions based on the real-time data and the resource allocation application 380 may utilize the real-time data to dynamically allocate the one or more resources 201 to the one or more users. In some embodiments, the sequence observer 610 may be a part of the pattern recognition application 360. The sequence observer 610 may continuously track the sequence of user actions associated with the one or more users and may store the sequences of user actions in the data repository 390. The sequence data may be extracted by the pattern recognition application 360 to establish one or more patterns associated with the one or more users. In response to establishing the one or more patterns, the pattern recognition application 360 stores the one or more patterns in the data repository 390 and transfers the one or more patterns to the resource allocation application 380 in real-time. In some embodiments, the resource allocation application 380 may also extract pattern data and other user data from the data repository 390. The resource allocation application 380 based on the real-time data from the one or more entity systems 200, the pattern data from the pattern recognition application 360, and the user data extracted from the data repository allocates the one or more resources 201 to the one or more users. In some embodiments, the system may also track the activity of the one or more users after allocation of the one or more resources 201 to the one or more users. In some embodiments, the system may also track the utilization of the one or more resources 201 by directly communicating with the one or more resources or by communicating with an entity system that manages the one or more resources 201. In such embodiments, the system may use the utilization data of the one or more resources 201 and the activity data of the one or more users to improve the efficiency of the allocation process such that the utilization of the one or more resources is maximized. One or more operations described herein may be performed on the closed distributed register.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for allocating resources to one or more users within an environment, the system comprising:
at least one network communication interface;
at least one non-transitory storage device; and
at least one processing device coupled to the at least one non-transitory storage device and the at least one network communication interface, wherein the at least one processing device is configured to:
register one or more users of an entity to a closed distributed register;
register one or more resources of the entity to the closed distributed register;
establish a communication link with one or more entity systems, wherein the one or more entity systems are located in the environment of the entity;
identify one or more patterns associated with the one or more users based on the communication link with the one or more entity systems; and
allocate the one or more resources to the one or more users based on the one or more patterns.

2. The system of claim 1, wherein the at least one processing device is configured to identify the one or more patterns based on tracking activity of the one or more users via the one or more entity systems for a period of time.

3. The system of claim 2, wherein the at least one processing device is configured to:
in response to identifying the one or more patterns of the one or more users, storing the one or more patterns in a data repository.

4. The system of claim 1, wherein the at least one processing device is configured to:
determine that at least one user is deviating from an established pattern associated with the at least one user based on the communication link with the one or more entity systems;
identify that at least one resource of the one or more resources is allocated to the at least one user; and
reallocate the at least one resource to at least one other user.

5. The system of claim 1, wherein the at least one processing device is configured to:
receive a request from a first user to reserve a first resource for a future time period, via the one or more entity systems; and
in response to receiving the request from the first user, allocate the first resource to the first user for the future time period.

6. The system of claim 1, wherein the one or more resources comprise at least one of tangible resources, intangible resources, digital resources, and dependent resources.

7. The system of claim 1, wherein the one or more entity systems comprise at least one of one or more entity applications, one or more mobile applications, and one or more independent platforms.

8. A computer program product for allocating resources to one or more users within an environment, the computer program product comprising at least one non-transitory computer-readable medium having computer-readable program code portions embodied therein, the computer-readable program code portions comprises one or more executable portions for:
registering one or more users of an entity to a closed distributed register;
registering one or more resources of the entity to the closed distributed register;
establishing a communication link with one or more entity systems, wherein the one or more entity systems are located in the environment of the entity;
identifying one or more patterns associated with the one or more users based on the communication link with the one or more entity systems; and
allocating the one or more resources to the one or more users based on the one or more patterns.

9. The computer program product of claim 8, wherein the one or more processing devices are configured to execute the computer readable code to identify the one or more patterns based on tracking activity of the one or more users via the one or more entity systems for a period of time.

10. The computer program product of claim 9, wherein the one or more processing devices are configured to execute the computer readable code to:
in response to identifying the one or more patterns of the one or more users, storing the one or more patterns in a data repository.

11. The computer program product of claim 8, wherein the one or more processing devices are configured to execute the computer readable code to:
determine that at least one user is deviating from an established pattern associated with the at least one user based on the communication link with the one or more entity systems;
identify that at least one resource of the one or more resources is allocated to the at least one user; and
reallocate the at least one resource to at least one other user.

12. The computer program product of claim 8, wherein the one or more processing devices are configured to execute the computer readable code to:
receive a request from a first user to reserve a first resource for a future time period, via the one or more entity systems; and
in response to receiving the request from the first user, allocate the first resource to the first user for the future time period.

13. The computer program product of claim 8, wherein the one or more resources comprise at least one of tangible resources, intangible resources, digital resources, and dependent resources.

14. The computer program product of claim 8, wherein the one or more entity systems comprise at least one of one or more entity applications, one or more mobile applications, and one or more independent platforms.

15. A computer implemented method for allocating resources to one or more users within an environment, the method comprises:
registering one or more users of an entity to a closed distributed register;
registering one or more resources of the entity to the closed distributed register;
establishing a communication link with one or more entity systems, wherein the one or more entity systems are located in the environment of the entity;
identifying one or more patterns associated with the one or more users based on the communication link with the one or more entity systems; and
allocating the one or more resources to the one or more users based on the one or more patterns.

16. The computer implemented method of claim 15, wherein the method further comprises identifying the one or more patterns based on tracking activity of the one or more users via the one or more entity systems for a period of time.

17. The computer implemented method of claim 16, wherein the method further comprises:
in response to identifying the one or more patterns of the one or more users, storing the one or more patterns in a data repository.

18. The computer implemented method of claim 15, wherein the method further comprises:
determining that at least one user is deviating from an established pattern associated with the at least one user based on the communication link with the one or more entity systems;
identifying that at least one resource of the one or more resources is allocated to the at least one user; and
reallocating the at least one resource to at least one other user.

19. The computer implemented method of claim 15, wherein the method further comprises:
receiving a request from a first user to reserve a first resource for a future time period, via the one or more entity systems; and
in response to receiving the request from the first user, allocating the first resource to the first user for the future time period.

20. The computer implemented method of claim 15, wherein the one or more resources comprise at least one of tangible resources, intangible resources, digital resources, and dependent resources.
